(19) United States
(12) Patent Application Publication
(10) Pub. No.: US 2016/0107510 A1
(43) Pub. Date: Apr. 21, 2016

(54) DOOR STRUCTURE FOR VEHICLE

(71) Applicant: HYUNDAI MOTOR COMPANY, Seoul (KR)

(72) Inventor: Dongmin JEON, Hwaseong-si (KR)

(21) Appl. No.: 14/806,245

(22) Filed: Jul. 22, 2015

(30) Foreign Application Priority Data
Oct. 17, 2014 (KR) 10-2014-0141172

(51) Int. Cl. B60J 1/17; B60J 5/04

(52) U.S. Cl. CPC B60J 1/17; B60J 5/0402; B60J 5/0419

(57) ABSTRACT

A door structure for a vehicle includes a door outer panel disposed on an outer side of the vehicle in the width direction of the vehicle and a door inner panel disposed inside the vehicle in the width direction of the vehicle. The door inner panel has an outer edge adjacent an outer edge of the door outer panel and is joined with the door outer panel at a plurality of bonding portions in a location other than the outer edge of the door inner panel.

### CROSS-REFERENCE TO RELATED APPLICATION

This application claims the benefit of priority to Korean Patent Application No. 10-2014-0141172 filed in the Korean Intellectual Property Office on Oct. 17, 2014, the entire contents of which are incorporated herein by reference.

### TECHNICAL FIELD

The present disclosure relates to a door for a vehicle. More particularly, embodiments of the present invention relate to a door structure for a vehicle, which reduces the entire thickness of a door and implements a slim door by closely combining a door inner panel with a door outer panel and mounting parts related to the door on the door inner panel.

### BACKGROUND

In general, a vehicle interior of a specific size in which a driver or passenger may ride is formed in the vehicle body of a vehicle. In order to open and shut the vehicle interior, vehicle interior opening/shutting doors are installed in the vehicle body.

In general, in the case of a passenger vehicle, the vehicle interior opening/shutting doors may include front doors installed at the front in the length direction of the vehicle and rear doors installed in the rear in the length direction of the vehicle. The front doors and the rear doors are rotatably installed in the vehicle body via hinges.

Such a conventional vehicle interior opening/shutting door or door for a vehicle, as illustrated in FIG. 1, includes a door outer panel 10 disposed on the outside in the width direction of the vehicle, a door inner panel 20 placed on the inside toward a vehicle interior in the width direction of the vehicle, integrally combined with the door outer panel 10, and configured to form a mounting space of a specific size between the door inner panel 20 and the door outer panel 10, and a door trim 30 installed on the inside toward the vehicle interior in the door inner panel 20 and configured to improve a sense of beauty and to have parts, such as switches related to a door and a door window, installed therein.

A support member 40 is attached to the door outer panel 10 in order to increase structural stiffness. In order to prevent excessive deformation of a door when a collision accident occurs on the side of the vehicle, a reinforcement member 50 is attached to the door outer panel 10. The inner rail 60 of a door frame is combined with the upper part of the door inner panel 20 in the height direction of the vehicle. An outer rail 70 is combined with the upper part of the door outer panel 10 that faces the inner rail 60 so that door window glass 80 is supported.

Furthermore, a door module 90 on which a window regulator is mounted is supported to the door inner panel 20.

In such a conventional door structure for a vehicle, however, the door inner panel and the door outer panel are spaced apart from each other and combined so that a mounting space on which parts related to the door are mounted is formed between the door inner panel and the door outer panel. Accordingly, there are disadvantages in that the thickness W of the door is increased and the weight of the vehicle is increased due to many parts because the support member of the door outer panel and the inner rail and outer rail related to the door window glass are installed.

The above information disclosed in this Background section is only for enhancement of understanding of the background of the invention and therefore it may contain information that does not form the prior art that is already known in this country to a person of ordinary skill in the art.

### SUMMARY

The present disclosure has been made in an effort to provide a door structure for a vehicle, which has advantages of achieving light weight by reducing the number of parts and weight and of implementing a slim door by reducing the entire thickness because a door outer panel and a door inner panel are closely joined.

An exemplary embodiment of the present invention provides a door structure for a vehicle, including a door outer panel disposed on an outer side of the vehicle in the width direction of the vehicle and a door inner panel disposed inside the vehicle in the width direction of the vehicle. The door inner panel has an outer edge adjacent an outer the edge of the door outer panel, and is joined with the door outer panel at a plurality of bonding portions in a location other than the outer edge of the door inner panel.

In certain embodiments, an opening may be formed in the door inner panel, and the plurality of bonding portions may be formed along the edge of the opening. In certain embodiments, the opening may be formed in a substantially central portion of the door inner panel.

In certain embodiments, the of bonding portions may be bonded to the door outer panel via a sealer.

In certain embodiments, the door inner panel may include a door trim disposed on an inner side in the width direction of the vehicle.

In certain embodiments, door structure may further include a door frame having a door window opening formed therein. The door frame may be joined to an upper part of the door inner panel in the height direction of the vehicle.

In certain embodiments, a reinforcement member may be mounted on an inside face of the door outer panel in the width direction of the vehicle.

In certain embodiments, the door structure may further include a door window glass regulator having two ends mounted on the door inner panel. The door window glass regulator may be configured to enable a door window glass to go up and down.

In certain embodiments, the door structure may further include a door hinge mounting bracket and a door latch mounting bracket, and an inner rail having opposing first and second ends connecting two ends of the door frame. One end of the door frame and the door latch mounting bracket and one end of the inner rail may be overlapped with and joined to with the door inner panel. The second end of the inner rail may be overlapped with and joined to the door hinge mounting bracket.

In certain embodiments, a door sealing face may be along the outer edge of the door inner panel extending towards the interior of the vehicle in the thickness direction, and a vehicle body-side sealing face may be formed along an outer edge of the door trim extending towards the interior of the vehicle in the thickness direction.

In certain embodiments, the door outer panel may have a square plate shape. In certain embodiments, the door inner panel may have a square plate shape. In certain embodiments, an upper part of the door outer panel may be joined to an upper part of the door inner panel. In certain embodiments, the door outer panel may not have a rail on the upper part thereof between the door outer panel and the door inner panel.

In accordance with the door structure for a vehicle according to an exemplary embodiment of the present invention, the frame structure of a door may be formed by joining the door inner panel with the door outer panel as closely as possible. Accordingly, a slim door can be implemented by reducing the entire thickness of the door. Furthermore, the degree of freedom of a vehicle and a vehicle door can be improved, and the marketability of a vehicle can be improved.

Furthermore, certain conventional parts for supporting the door outer panel and certain conventional parts for the door glass rail may not be required because the door inner panel may be combined with the door outer panel so that it effectively supports the door outer panel. Accordingly, the number of parts and weight can be reduced, light weight can be achieved, costs can be reduced, and vehicle fuel consumption can be enhanced.

Moreover, there are advantages in that the shaking noise of the door outer panel may be reduced and the marketability of a vehicle can be improved because the door inner panel strongly supports the door outer panel, productivity can be improved because the workability assembly of parts that form the door can be improved, and the design of the vehicle and the degree of freedom of the design can be improved.

### BRIEF DESCRIPTION OF THE DRAWINGS

FIG. 1 is a cross-sectional view of a conventional door structure for a vehicle in the related art.

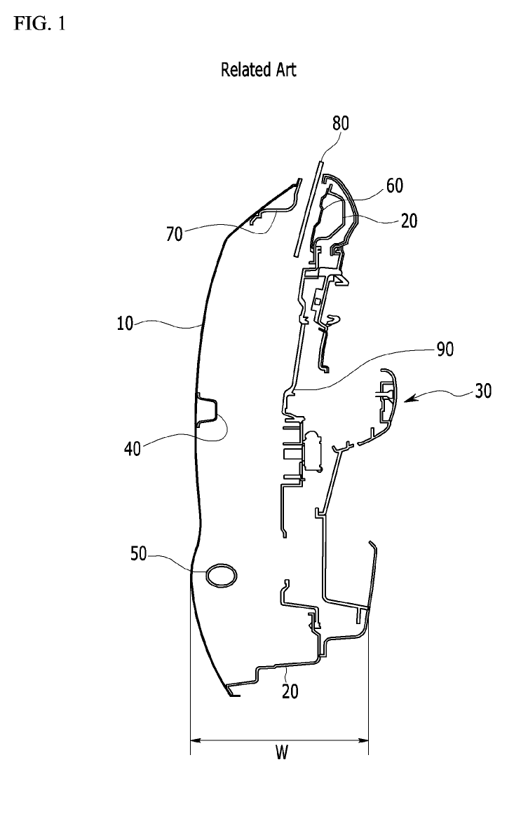

FIG. 2 is a perspective view of a door structure for a vehicle in accordance with an exemplary embodiment of the present invention.

FIG. 3 is an exploded perspective view of the door structure for a vehicle in accordance with an exemplary embodiment of the present invention.

FIG. 4 is a cross-sectional view of the door structure for a vehicle in accordance with an exemplary embodiment of the present invention.

FIG. 5 is a view from outside of the vehicle in the width direction of the vehicle of a door inner panel in accordance with an exemplary embodiment of the present invention.

FIG. 6 is a perspective view illustrating that the door inner panel and a door frame are combined in accordance with an exemplary embodiment of the present invention.

FIG. 7 is a perspective view illustrating the state in which a door window glass has been mounted on the door structure for a vehicle in accordance with an exemplary embodiment of the present invention.

### DETAILED DESCRIPTION

Hereinafter, exemplary embodiments of the present invention are described in detail with reference to the accompanying drawings.

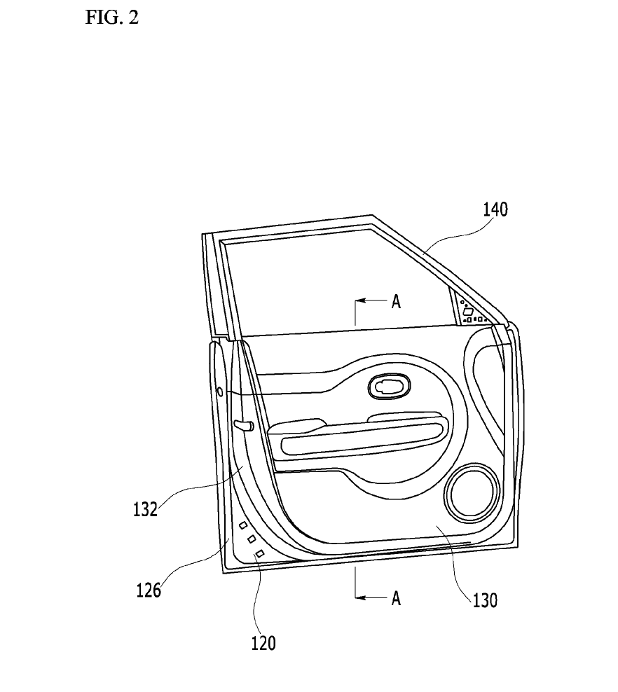

Referring to FIGS. 2 to 4, a door structure for a vehicle in accordance with an exemplary embodiment of the present invention may include a door outer panel 110 placed on the outside in the width direction of the vehicle and a door inner panel 120 placed on the inside toward a vehicle interior in the width direction of the vehicle and integrally combined with the door outer panel 110. In certain embodiments, a door trim 130 is mounted on the inside toward the vehicle interior in the door inner panel 120 and configured to improve a sense of aesthetics and have parts, such as switches related to a door and a door window, installed therein. In certain embodiments, a door frame 140 is combined with the door inner panel 120 on the upper part in the height direction of the vehicle and configured to have a door window opening 142 formed therein.

The door outer panel 110, the door inner panel 120, and the door frame 140 form a door structure.

In certain embodiments, the door outer panel 110 may generally have a square plate shape.

In certain embodiments, the door inner panel 120 may generally have a square plate shape, and an opening 122 may be formed at the central portion of the door inner panel 120. Alternatively, the opening 122 may be formed in another portion of the door inner panel 120.

In certain embodiments, a reinforcement member 150 for added protection during a collision on the side of the vehicle may be mounted on the inside of the door outer panel 110 in the width direction of the vehicle.

In certain embodiments, the reinforcement member 150 may have a cross section having one or more of various shapes configured to increase structural stiffness.

In order for a door window glass 170 to go up and down, in certain embodiments, a door window glass regulator 160 may be disposed in the height direction of the vehicle, and may have both ends thereof mounted on and supported to the door inner panel 120.

In certain embodiments, an inner rail 144 may be integrally joined with the door frame 140 in order to secure the stiffness of the door window opening 142.

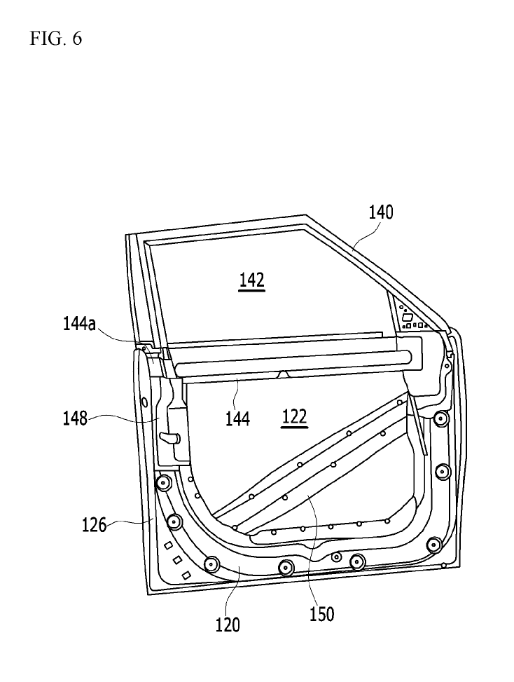

The inner rail 144 may connect both ends of the door frame 140 (refer to FIG. 6).

In certain embodiments, the door inner panel 120 may be integrally joined with the door outer panel 110 such that it is as close as possible to the door outer panel 110. Accordingly, the thickness W1 of the door can be significantly reduced compared to the conventional thickness W (W1<W) because the mounting space between the door inner panel 120 and the door outer panel 110 is removed, thereby enabling the implementation of a slim door.

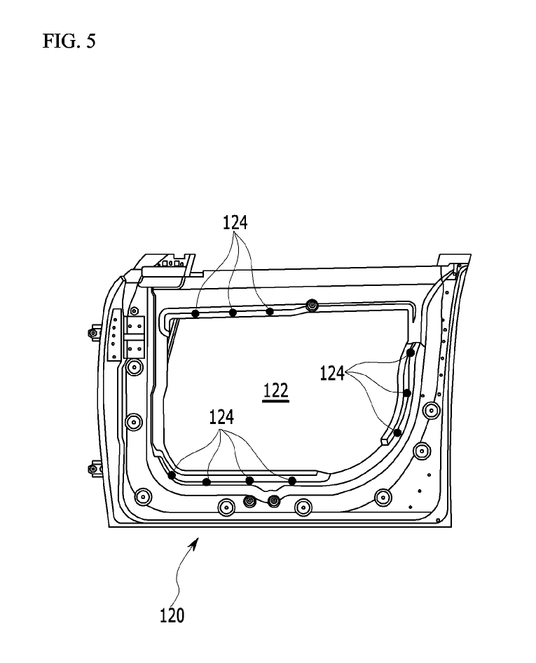

In certain embodiments, the door outer panel 110 and the door inner panel 120 may be combined through a hemming process of winding and combining edges. The outer edge 111 of the door outer panel 110 may be adjacent the outer edge 121 of the door inner panel 120. Referring to FIG. 5, bonding portions 124 bonded to the door outer panel 110 may be formed, in certain embodiments, at a plurality of portions along the edge of the center opening 122 of the door inner panel 120. However, the location of bonding portions 124 is not limited to the edge of the center opening 122 and may be formed at any location other than the outer edge 121 of the door inner panel 120.

In certain embodiments, the bonding portions 124 may be integrally bonded to the door outer panel 110 via a sealer, for example.

As described above, when the door inner panel 120 is bonded to the door outer panel 110 through a plurality of the bonding portions 124, the door inner panel 120 can increase the structural stiffness of the door outer panel 110. Accordingly, the number of parts and weight can be reduced because conventional support members for supporting the door outer panel are not required.

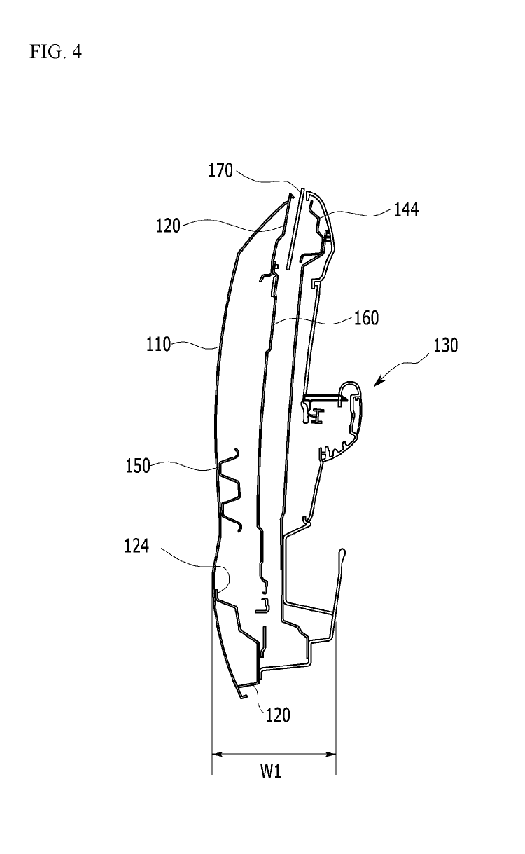

Furthermore, as illustrated in FIG. 4, in certain embodiments, the upper part of the door inner panel 110 can be used instead of a conventional outer rail because may be joined with the upper part of the door outer panel 110. Accordingly, the number of parts and weight can be reduced because a conventional outer rail is not required.

Both ends of the door window glass regulator 160 can be directly mounted on and supported to the door inner panel 120 because structural stiffness is increased by the direct strong combination of the door inner panel 120 and the door outer panel 110. Accordingly, the number of parts and weight can be reduced and light weight can be achieved because a conventional door module including a regulator is not required.

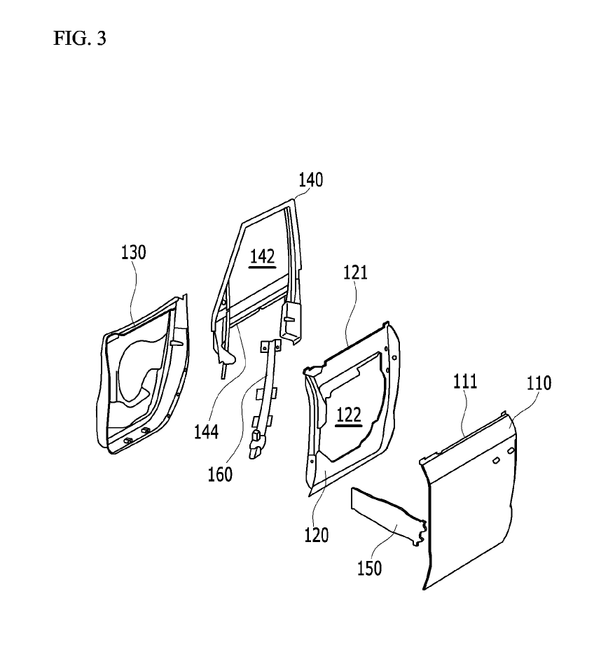

Referring to FIGS. 3 and 6, in certain embodiments, a door latch mounting bracket 148 may be joined with one end of the door frame 140.

At one end of the door frame 140, the door latch mounting bracket 148 and a first end 144a of the inner rail 144 may be overlapped and combined with the door inner panel 120.

Such a combination structure can improve the assembly because a welding gun can easily enter the combination structure.

In certain embodiments, a door sealing face 126 is formed along the outer edge of the door inner panel 120 extending towards the interior of the vehicle in the thickness direction thereof. In this case, slimness can be achieved because the thickness of the door is reduced compared to a conventional door in which vehicle body-side sealing faces are formed in two stages in addition to the door sealing face.

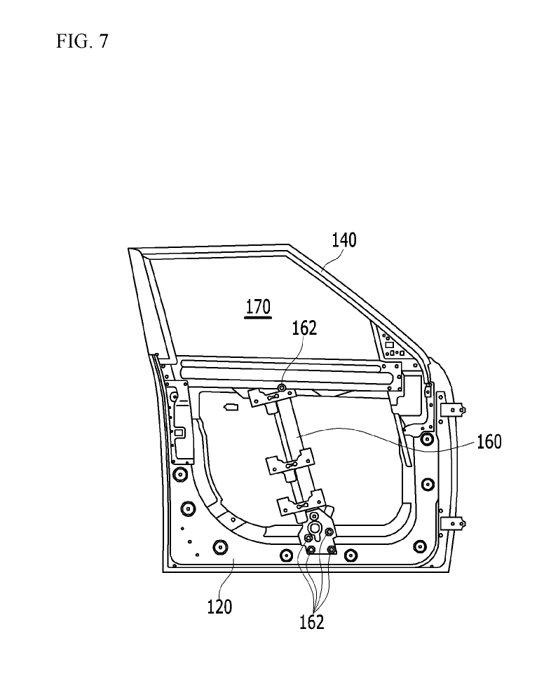

Referring to FIG. 7, in certain embodiments, both ends of the door window glass regulator 160 may be engaged and joined with the door inner panel 120 via engaging portions 162.

The assembly workability of the door window glass regulator 160 can be improved because the door window glass regulator 160 can be engaged with and mounted on the door inner panel 120 from the vehicle interior.

Furthermore, a task for installing the door window glass can be facilitated because a mechanism space in which the door window glass 170 goes up and down is secured on the vehicle interior side.

Referring to FIG. 2, in certain embodiments, the door sealing face 126 is formed on the door inner panel 120 extending towards the interior of the vehicle in the thickness direction thereof, and a vehicle body-side sealing face 132 is formed along an outer edge of the door trim 130 in the thickness direction thereof towards the interior of the vehicle. Accordingly, door slimness can be implemented because the thickness of the door is significantly reduced compared to a prior art. Furthermore, a speaker, etc. may be mounted on the space with the door inner panel 120 secured by the vehicle body-side sealing face 132 that is formed on the door trim 130.

While embodiments of the present invention have been disclosed herein, it is to be understood that the invention is not limited to the disclosed embodiments, but, on the contrary, is intended to cover various modifications and equivalent arrangements included within the spirit and scope of the appended claims.

What is claimed is:

1. A door structure for a vehicle, comprising:
a door outer panel disposed on an outer side of the vehicle in a width direction of the vehicle, the door outer panel having an outer edge; and
a door inner panel disposed inside the vehicle in the width direction of the vehicle, the door inner panel having an outer edge adjacent the outer edge of the door outer panel and joined with the door outer panel at a plurality of bonding portions in a location other than the outer edge of the door inner panel.

2. The door structure of claim 1, wherein
an opening is formed in the door inner panel, and
the bonding portions are formed along an edge of the opening.

3. The door structure of claim 1, wherein
the opening is formed in a substantially central portion of the door inner panel.

4. The door structure of claim 1, wherein the bonding portions are bonded to the door outer panel via a sealer.

5. The door structure of claim 1, wherein the door inner panel comprises a door trim disposed on an inner side in the width direction of the vehicle.

6. The door structure of claim 1, further comprising a door frame having a door window opening formed therein, the door frame joined to an upper part of the door inner panel in a height direction of the vehicle.

7. The door structure of claim 1, wherein a reinforcement member is mounted on an inside face of the door outer panel in the width direction of the vehicle.

8. The door structure of claim 1, further comprising a door window glass regulator having two ends mounted on the door inner panel, the door window glass regulator configured to enable a door window glass to go up and down.

9. The door structure of claim 6, further comprising:
a door hinge mounting bracket and an inner rail having opposing first and second ends connecting two ends of the door frame, and
wherein one end of the door frame, the door latch mounting bracket and the first end of the inner rail are overlapped with and joined to the door inner panel.

10. The door structure of claim 5, wherein:
a door sealing face is formed along the outer edge of the door inner panel extending towards the interior of the vehicle in a thickness direction, and
a vehicle body-side sealing face is formed along an outer edge of the door trim extending towards the interior of the vehicle in the thickness direction.

11. The door structure of claim 1, wherein the door outer panel has a square plate shape.

12. The door structure of claim 1, wherein the door inner panel has a square plate shape.

13. The door structure of claim 1, wherein an upper part of the door outer panel is joined to an upper part of the door inner panel.

14. The door structure of claim 13, wherein the door outer panel does not have a rail on the upper part thereof between the door outer panel and the door inner panel.
